(19) United States
(12) Patent Application Publication
(10) Pub. No.: US 2013/0074490 A1
(43) Pub. Date: Mar. 28, 2013

(54) STIRLING CYCLE ENGINE

(71) Applicants: Yoshio NARISAWA, Tsubame-shi (JP); Tsuneo YAMAGIRI, Tsubame-shi (JP)

(72) Inventors: Yoshio NARISAWA, Tsubame-shi (JP); Tsuneo YAMAGIRI, Tsubame-shi (JP)

(73) Assignee: TWINBIRD CORPORATION, Tsubame-shi (JP)

(21) Appl. No.: 13/619,374

(22) Filed: Sep. 14, 2012

(30) Foreign Application Priority Data
Sep. 22, 2011 (JP) 2011-207252

(51) Int. Cl. F02G 1/053

(52) U.S. Cl. 60/517

(57) ABSTRACT

Provided is a Stirling cycle engine capable of being downsized without decreasing an assembling efficiency. A flange section as a fitting section is formed on one end of an inner core. A retainer plate as a retaining member for the flange section, holds and fixes the same with the aid of a second side surface of a mount integrally formed on a proximal end section of a cylinder, thus substantially coaxially arranging the cylinder and inner core. Accordingly, regardless of a thermal expansion difference between the cylinder and inner core, generation of impurity gas can be prevented; deformations of the cylinder and the inner core; and tremble of the inner core. Further, a conventional proximal end portion of the cylinder is not needed for fixing the inner core, thus reducing an outer diameter of a driving mechanism, eventually, an outer diameter of a casing.

### CROSS-REFERENCE TO PRIOR APPLICATION

This application claims priority to Japanese Patent Application No. 2011-207252, filed Sep. 22, 2011. This application is incorporated herein by reference.

### FIELD OF THE INVENTION

The present invention relates to a free-piston type Stirling cycle engine.

### BACKGROUND

Conventionally, as a Stirling cycle engine of such type, there has been disclosed a Stirling cycle engine (e.g., Japanese Patent No. 3769751) provided with: a casing composed of a cylindrical portion and a body portion; a driving mechanism disposed inside the body portion; and a cylinder disposed inside the casing. This type of Stirling cycle engine is further provided with: a piston disposed inside the cylinder and capable of being reciprocated by the driving mechanism; and a displacer also capable of being reciprocated in conjunction with the piston by a phase difference. Further, a magnetism inductor (equivalent to an inner core of the present invention) is fixed to an outer circumference of the cylinder, the magnetism inductor being a ferromagnetic member made of steel and serving as a stator unit of the driving mechanism. Furthermore, fixed to a flange section of the cylinder are a laminated core (equivalent to an outer core of the present invention) and an electromagnetic coil, the laminated core and the electromagnetic coil also serving as stator units of the driving mechanism. Here, the cylinder is often made of an aluminum alloy.

However, the aforementioned Stirling cycle engine raises a concern of causing the magnetism inductor to tremble and the cylinder to deform, due to a difference in thermal expansion coefficients between the aluminum alloy and steel. Other concerns about the aforementioned Stirling cycle engine are that the tremble of the magnetism inductor not only causes noise and vibration, but also causes the cylinder and the magnetism inductor themselves to wear away, thus leading to malfunction. A problem imposed by the aforementioned Stirling cycle engine is that while the tremble of the magnetism inductor can be prevented by, for example, using an adhesive agent to fix the magnetism inductor, the usage of such adhesive agent not only leads to a decreased assembling workability, but also causes a gas to be generated from the adhesive agent with long-term use. Particularly, the aforementioned Stirling cycle engine, when mounted in a high-performance refrigerator, imposes a problem of undergoing performance degradation due to the fact that the aforementioned gas may be liquefied or frozen. Here, there is also a concern that a deformation of the cylinder, regardless of the magnitude thereof, may lead to a movement problem of the piston due to the fact that only a small space is formed between the cylinder and the piston. Moreover, there is also a problem that while the deformation of the cylinder can be restricted by increasing a thickness thereof, the increase in the thickness of the cylinder leads to an increase in an outer diameter of the casing.

### SUMMARY

The present invention solves the aforementioned problems and concerns by providing a Stirling cycle engine capable of being downsized without decreasing an assembling efficiency.

A Stirling cycle engine according to a first aspect of the present invention has: a cylinder; a piston capable of being reciprocated inside the cylinder; a driving mechanism composed of: a movable unit including a permanent magnet and being fixed to and disposed outside the piston; and a stator unit including a cylindrical inner core disposed inside the movable unit, and an outer core and an electromagnetic coil that are disposed outside the movable unit; a fitting section formed on one end of the inner core; and a retaining member, corresponding to the fitting section, in which the retaining member serves to hold and fix the fitting section of the inner core with an aid of an end section of the cylinder such that the cylinder and the inner core can be substantially coaxially arranged.

According to a Stirling cycle engine as set forth in a second aspect of the present invention that is related to the first aspect of the present invention, the fitting section is a flange-shaped section formed on the one end of the inner core, and the retaining member is a ring-shaped member.

According to a Stirling cycle engine as set forth in a third aspect of the present invention that is related to the first aspect of the present invention, the fitting section is a concave groove formed on an outer circumference of the one end of the inner core, and the retaining member is a ring-shaped member inserted into the fitting section.

According to a Stirling cycle engine as set forth in a fourth aspect of the present invention that is related to the first aspect of the present invention, the retaining member is an elastic member, and abuts against the fitting section while being elastically deformed.

According to a Stirling cycle engine as set forth in a fifth aspect of the present invention that is related to the second aspect of the present invention, the retaining member is an elastic member, and the fitting section is formed to a thickness larger than a depth of a concave groove formed on the end section of the cylinder, thereby allowing the fitting section to protrude from the end section of the cylinder when inserted into the concave groove, thus causing the retaining member, when fixed to the end section of the cylinder, to abut against the fitting section while being elastically deformed.

According to a Stirling cycle engine as set forth in a sixth aspect of the present invention that is related to the third aspect of the present invention, the retaining member is an elastic member, and a distance between the one end of the inner core and a side wall in the fitting section of the inner core is larger than a depth of a concave groove formed on the end section of the cylinder, thereby allowing the side wall in the fitting section of the inner core to protrude from the end section of the cylinder with the one end of the inner core being inserted into the concave groove, thus causing the retaining member, when fixed to the end section of the cylinder, to abut against the fitting section while being elastically deformed.

According to the Stirling cycle engine as set forth in the first aspect of the present invention, even when there exists a thermal expansion difference between the cylinder and the inner core due to a difference in materials thereof, a generation of impurity gas can be prevented, and the inner core is less likely to tremble and deform. In addition, the cylinder no longer needs to have a conventional proximal end portion needed to fix the inner core, thus reducing the outer diameter of the driving mechanism and eventually the outer diameter of the casing.

According to the Stirling cycle engine as set forth in the fourth aspect of the present invention, the retaining member abuts against the fitting section of the inner core while being elastically deformed, and thereby serves to hold and fix the corresponding fitting section with the aid of the end section of the cylinder. Accordingly, the retaining member can keep holding the fitting section even when the cylinder expands more largely than the inner core, thus preventing the inner core from trembling.

### BRIEF DESCRIPTION OF THE DRAWINGS

FIG. 1 is a vertical cross-sectional view showing a Stirling cycle engine of a first embodiment of the present invention.

FIG. 2 is a horizontal cross-sectional view showing a main section of the Stirling cycle engine of the first embodiment.

FIG. 3 is an enlarged cross-sectional view of a main section of the Stirling cycle engine of the first embodiment shown in FIG. 1

FIG. 4 is an enlarged cross-sectional view showing a main section of a Stirling cycle engine of a second embodiment of the present invention.

FIG. 5 is a horizontal cross-sectional view showing a main section of the Stirling cycle engine of the second embodiment.

### DETAILED DESCRIPTION OF THE INVENTION

Preferred embodiments of the present invention are described hereunder with reference to the accompanying drawings. However, the following embodiments shall not limit the contents of the present invention that are described in the claims. Further, not all elements described hereunder are necessarily the essential elements of the present invention.

### First Embodiment

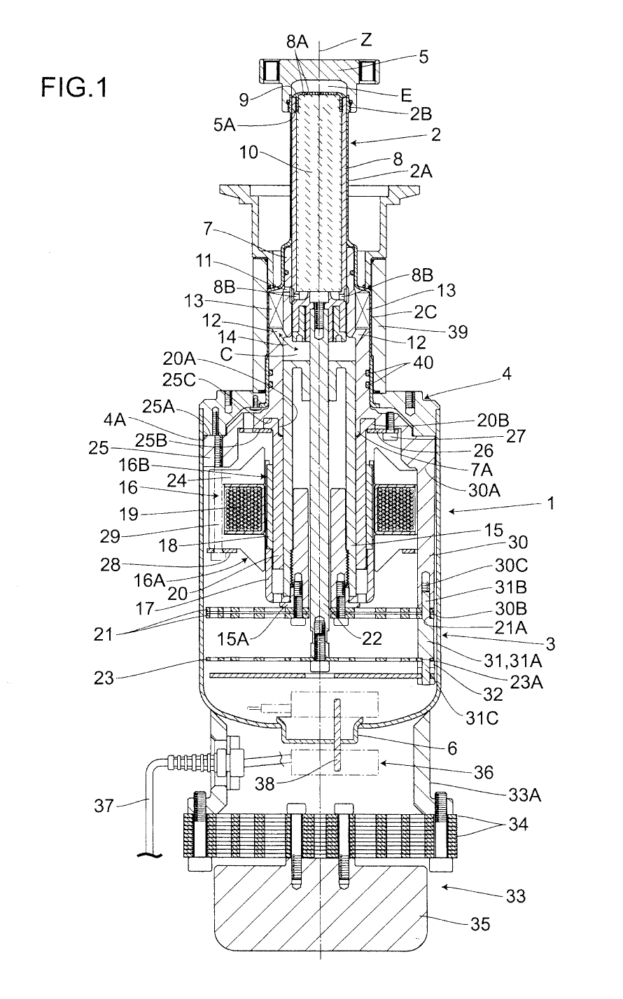

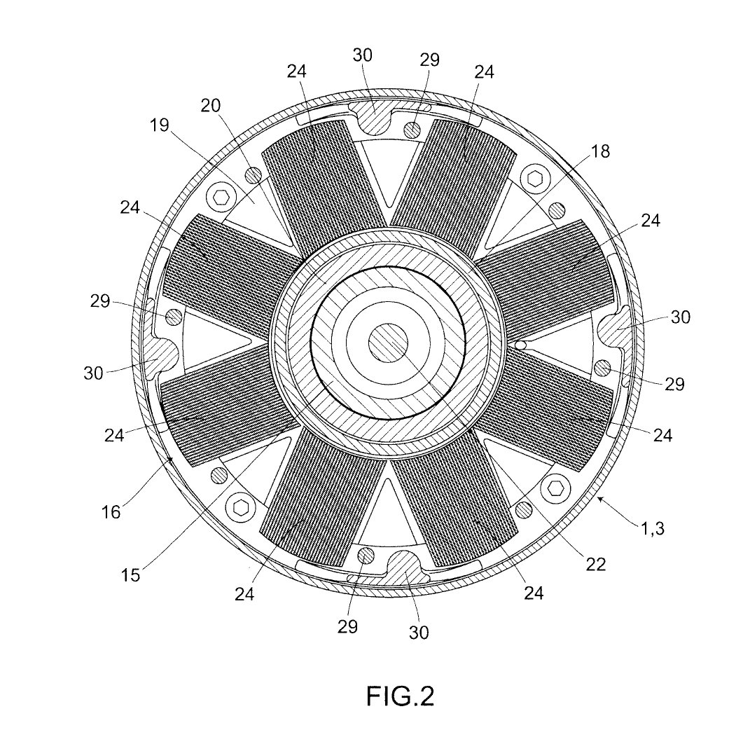

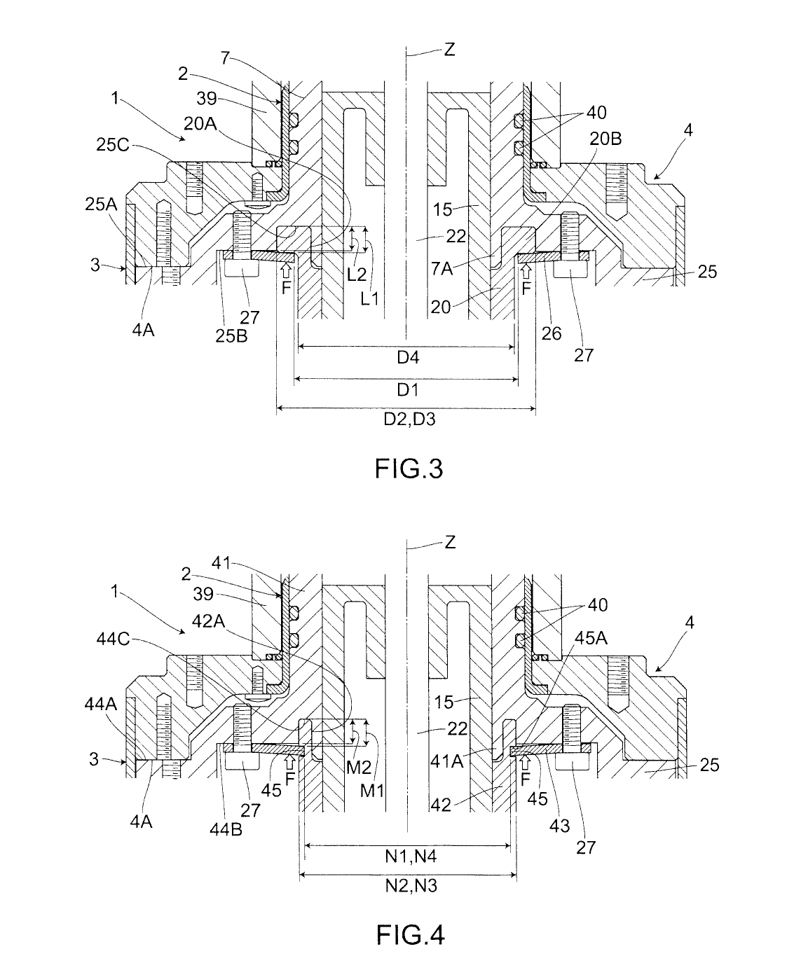

A first embodiment of the present invention is described hereunder with reference to the accompanying drawings. In the following description, an upper side and a lower side in FIG. 1 and FIG. 3 are defined as a distal end side and a proximal end side, respectively. In FIG. 1 through FIG. 3, a symbol “1” represents a casing composed of: a cylindrical portion 2 formed into a substantially cylindrical shape; a body portion 3; a coupling member 4; a heat absorbing block 5; and a hermetic seal 6. The cylindrical portion 2, the body portion 3 and the coupling member 4 are respectively made of stainless steel or the like. Further, the hermetic seal 6 is made of steel or the like. Meanwhile, the heat absorbing block 5 is made of copper or the like. Here, the cylindrical portion 2 has two open ends and a male screw section 2B formed on an outer circumference of a distal end section 2A of the corresponding cylindrical portion 2. Further, a cutting operation has been performed on an inner surface of the distal end section 2A such that a cross-sectional surface of the distal end section 2A can be precisely formed into a circular shape. This allows the inner surface of the distal end section 2A of the cylindrical portion 2 to serve as that of a cylinder. Further, the heat absorbing block 5 includes a female screw section 5A corresponding to the aforementioned male screw section 2B. Here, the casing 1 is structured as follows. That is, the cylindrical portion 2 and the body portion 3 are coupled with each other through the substantially ring-shaped coupling member 4, with the aid of brazing or the like. Further, the body portion 3 and the hermetic seal 6 are also coupled with each other through brazing or the like. Furthermore, the distal end section of the cylindrical portion 2 and the heat absorbing block 5 are coupled with each other in a manner such that the male screw section 2B and the female screw section 5A are screwed together with and brazed to each other. Namely, the opened distal end of the cylindrical portion 2 is sealed by the heat absorbing block 5. Here, a later-described power terminal 38 is fixed to the hermetic seal 6 in an insulated manner by means of a glass or the like.

A cylinder 7 extending beyond the coupling member 4 is provided inside a proximal end side section of the cylindrical portion 2 by being coaxially (axis Z) inserted thereinto. Here, a section of the cylinder 7 that is close to the body portion 3, integrally includes a later-described mount 25 and connecting arms 30. Particularly, the cylinder 7, the mount 25 and the connecting arms 30 are manufactured through: a casting such as a die-casting using an aluminum alloy or the like; and a cutting operation performed thereafter. A displacer 8 of a hollow cylindrical shape is slidably accommodated inside a distal-end side section of the cylinder 7 and the distal end section 2A of the cylindrical portion 2, the displacer 8 being slidable in the direction of the axis Z. Further, an expansion chamber E is formed between a distal end of the displacer 8 and the heat absorbing block 5. Furthermore, a lid member 9 attached to the distal end of the displacer 8 includes a plurality of vent holes 8A formed thereon. These vent holes 8A allow an inner section of the displacer 8 and the expansion chamber E to be communicated with each other. Further, the displacer 8 also includes a plurality of vent holes 8B formed on a proximal end section thereof. Here, a regenerator 10 is provided inside the displacer 8. Within the aforementioned cylindrical portion 2, the cylinder 7 integrally includes at least one first communication hole 11 and at least one second communication hole 12 that serve to connect inner and outer sides of the cylinder 7 to each other. Further, a heat dissipating fin 13 is provided between an inner surface of the cylindrical portion 2 and an outer surface of the cylinder 7, which is a location between the first communication hole 11 and the second communication hole 12. In this way, there is formed a path 14 starting from the expansion chamber E and ending at a compression chamber C, the path 14 successively passing through the vent holes 8A, the regenerator 10, the vent holes 8B, the first communication hole 11, the heat dissipating fin 13 and the second communication hole 12. Further, a distal end section of a piston 15 is slidably accommodated inside a proximal end side section of the cylinder 7, the distal end section of the piston 15 ranging from an inner section of a proximal end section 2C of the cylindrical portion 2 to an inner section of the coupling member 4, and being slidable in the direction of the axis Z. Furthermore, a proximal end section of the piston 15 is coaxially (axis Z) connected to a driving mechanism 16. Here, the driving mechanism 16 is connected to a proximal end of the piston 15 through a connecting member 15A, and includes: a short-cylindrical supporting member 17 extendedly and coaxially provided on an outer circumference of a proximal end side section of the piston 15; a cylindrical permanent magnet 18 fixed to one end of the supporting member 17; an annular electromagnetic coil 19 provided close to an outer circumference of the permanent magnet 18; and an inner core 20 provided close to an inner circumference of the permanent magnet 18.

A proximal end side section of the cylinder 7 includes an extended section 7A protruding in the direction of the axis Z. Further, a concave section 20A corresponding to the extended section 7A is formed on an inner side of a distal end section of the inner core 20. Accordingly, the extended section 7A and the concave section 20A allow the inner core 20 to be positioned to the cylinder 7.

Here, the connecting member 15A is connected to a plurality of first flat springs 21 for controlling a movement of the piston 15. Further, a proximal end side section of the aforementioned displacer 8 is connected to one end of a rod 22 for controlling a movement of the corresponding displacer 8, the rod 22 having an other end thereof connected to a second flat spring 23. Particularly, the rod 22 extends through the piston 15. As for the first flat springs 21 and the second flat spring 23 that are provided inside the body portion 3, the first flat springs 21 and the second flat spring 23 are actually provided closer to a proximal end section of the body portion 3 than a proximal end section of the inner core 20, and the second flat spring 23 is provided closer to the proximal end section of the body portion 3 than the first flat springs 21. Here, an outer core 24 is provided around the aforementioned electromagnetic coil 19. The outer core 24 is formed of a plurality of magnetic steel sheets that have appropriate shapes and are stacked in layers. Meanwhile, the inner core 20 is obtained by forming an iron powder into an appropriate shape and then sintering the same, the iron powder being a ferromagnetic substance covered with an insulator (e.g., synthetic resin) in advance. In fact, the outer core 24 can be structured using a method similar to the method with which the inner core 20 is obtained. Further, the driving mechanism 16 includes: a stator unit 16A composed of the electromagnetic coil 19, the inner core 20 and the outer core 24; and a movable unit 16B composed of the supporting member 17 and the permanent magnet 18.

A proximal end section of the cylinder 7 integrally includes a flange-shaped mount 25 coaxially protruding therefrom. The mount 25 is so configured that a first side surface 25A formed on a distal end side thereof abuts against and is screwed to a mounting section 4A of the coupling member 4. Meanwhile, on a second side surface 25B located on a proximal end side of the mount 25, there is formed an annular concave groove 25C surrounding the extended section 7A. The concave groove 25C allows a flange section 20B of the inner core 20 to be inserted thereinto in the direction of the axis Z, the flange section 20B being formed outside the distal end section of the inner core 20 and serving as a flange-shaped fitting section. Here, a thickness L1 of the flange section 20B in the direction of the axis Z is formed slightly larger than a depth L2 of the concave groove 25C in the direction of the axis Z (L1>L2). For this reason, the flange section 20B, when inserted into the concave groove 25C, slightly protrudes from the second side surface 25B toward a proximal end side of the axis Z. Further, screwed outside the concave groove 25C of the second side surface 25B through screws 27, is a retainer plate 26 serving as a ring-shaped retaining member that is substantially coaxially disposed with respect to the cylinder 7 and the inner core 20. Here, an inner diameter D1 of the retainer plate 26 is formed smaller than an outer diameter D2 of the concave groove 25C and an outer diameter D3 of the flange section 20B (D1<D2, D1<D3). However, the inner diameter D1 of the retainer plate 26 is formed slightly larger than an outer diameter D4 of the inner core 20 (D1>D4). The retainer plate 26 is made of an elastic material such as spring steel, stainless steel or the like. Further, a fixation ring 28 abuts against a proximal end side of the outer core 24. Here, the fixation ring 28 and the mount 25 serve to securely sandwich the outer core 24 therebetween with the aid of screws 29, thus allowing the outer core 24 and the electromagnetic coil 19 to be fixed to the mount 25. Moreover, a plurality of the connecting arms 30 protrude from the second side surface 25B of the mount 25 in a manner such that the connecting arms 30 are substantially parallel to the direction of the axis Z of the cylinder 7. Here, the connecting arms 30 are integrally formed on the mount 25 through proximal ends 30A thereof. Further, end surfaces 30B of the connecting arms 30 are formed on a same plane in a manner such that the end surfaces 30B are orthogonal to the direction of the axis Z of the cylinder 7. Furthermore, female screw holes 30C are formed on the end surfaces 30B in a manner such that the female screw holes 30C are parallel to the direction of the axis Z of the cylinder 7. Since the mount 25 and the connecting arms 30 are integrally formed on the cylinder 7, the precisions of the cylinder 7, the mount 25 and the connecting arms 30 can be improved.

The end surfaces 30B of the connecting arms 30 abut against the first flat springs 21. The first flat springs 21 are held between the connecting arms 30 and spacers 31, while abutting against the end surfaces 30B. Here, each spacer 31 includes a main body 31A formed into a shape of a regular hexagonal prism. Further, a male screw 31B coaxial with the main body 31A is formed on one end of the spacer 31 and is screwed together with a female screw hole 30C. Furthermore, on an other end of the spacer 31, there is formed a male screw 31C coaxial with the main body 31A. Particularly, the male screws 31B formed on the one ends of the spacers 31 are screwed together with the female screw holes 30C of the connecting arms 30 through screw holes 21A formed on an outer circumference of the first flat springs 21, thereby allowing the first flat springs 21 to be sandwiched between the connecting arms 30 and the spacers 31. Here, since the main bodies 31A of the spacers 31 are formed into a shape of a regular hexagonal prism, the spacers 31 can be easily fixed to the connecting arms 30 when screwed by a wrench or the like. Further, since a plurality of the end surfaces 30B are formed on the same plane in the manner such that the end surfaces 30B are orthogonal to the direction of the axis Z of the cylinder 7, the first flat springs 21 abutting against the end surfaces 30B are also orthogonal to the direction of the axis Z of the cylinder 7.

With the spacers 31 being individually attached to the plurality of the connecting arms 30, nuts 32 are then screwed together with the male screws 31C of the spacers 31 through screw holes 23A formed on an outer circumference of the second flat spring 23, thereby allowing the second flat spring 23 to be fixed to the spacers 31. The manner by which the spacers 31 are attached to the connecting arms 30, allows the first flat springs 21 to be held therebetween. Moreover, since the second flat spring 23 is further attached to the spacers 31, the first flat springs 21 and the second flat spring 23 that are independent from each other can be easily fixed with respect to the cylinder 7. Here, since the first and second flat springs 21, 23 are attached with respect to common connecting arms 30, a structure for fixing the first flat springs 21 and the second flat spring 23 can be simplified, thereby making it possible to downsize the Stirling cycle engine as a whole. Further, the female screw holes 30C are formed on the end surfaces 30B of the connecting arms 30, and the male screws 31B screwable with the corresponding female screw holes 30C are formed on the spacers 31, thereby enabling successive fixations of the first flat springs 21 and the second flat spring 23, thus making it easier to fix the first flat springs 21 and the second flat spring 23 with respect to the cylinder 7.

A symbol “33” in the accompanying drawings represents a vibration absorbing unit provided on a proximal end of the casing 1. The vibration absorbing unit is so arranged that a plurality of flat springs 34 and a balance weight 35 are coaxially mounted next to each other through a coupling member 33A disposed on the axis Z of the cylinder 7. Further, a symbol “36” in the accompanying drawings represents a power connector for supplying power to the aforementioned driving mechanism 16, and a symbol “37” in the accompanying drawings represents a power cord. Here, the power connector 36 is connected to the power terminal 38 fixed to the hermetic seal 6 in the insulated manner. Further, a symbol “39” in the accompanying drawings represents a cylindrical heat dissipating member for dissipating to the outside a heat that has travelled through the cylindrical portion 2 from the heat dissipating fin 13. Furthermore, a symbol “40” in the accompanying drawings represents O-rings for separating the aforementioned path 14 and a back space from each other.

Next, there is described a manufacturing process of the Stirling cycle engine of the present embodiment. In the beginning, the cylindrical portion 2, the coupling member 4 and the heat absorbing block 5 are to be integrally coupled to one other in advance. Further, the body portion 3 and the hermetic seal 6 are also to be integrally coupled to each other in advance. The cylinder 7 is then fixed to the casing 1 by allowing the first side surface 25A of the mount 25 to abut against and be screwed to the mounting section 4A of the coupling member 4. Particularly, the cylinder 7 is to be inserted into the cylindrical portion 2 by having the outer surface thereof guided by an inner surface of the proximal end section 2C of the cylindrical portion 2. In this way, the cylinder 7 can be arranged coaxially with respect to the cylindrical portion 2. Further, with the inner core 20 being positioned to the cylinder 7 through the extended section 7A and the concave section 20A, the aforementioned flange section 20B is then inserted into the concave groove 25C, followed by screwing the retainer plate 26 to the second side surface 25B of the mount 25 through the screws 27, thus allowing the flange section 20B to be held and fixed between the concave groove 25C and the retainer plate 26 in the direction of the axis Z. Furthermore, the electromagnetic coil 19 and the outer core 24 are to be fixed to the mount 25 integrally formed on the cylinder 7, through the aforementioned fixation ring 28 and the screws 29. As a result, the stator unit 16A of the driving mechanism 16 is fixed to the cylinder 7. Further, the supporting member 17 with the permanent magnet 18 insert molded therein is to be held by a proximal end of the piston 15 and the connecting member 15A, thus allowing the movable unit 16B of the driving mechanism 16 to be fixed the piston 15. Furthermore, the displacer 8 and the piston 15 are to be incorporated into the cylinder 7, followed by allowing the first flat springs 21 attached to the connecting member 15A at the proximal end of the piston 15 to be held and fixed between the connecting arms 30 and the spacers 31, and then fixing to the other ends of the spacers 31 the second flat spring 23 connected to a proximal end of the rod 22 that is connected to the displacer 8. Subsequently, the body portion 3 is to be integrally coupled with the coupling member 4, followed by attaching to the corresponding body portion 3 the aforementioned vibration absorbing unit 33 that has been assembled in advance.

Next, there are described functions of the present embodiment. The aforementioned structure allows an alternating magnetic field to be generated from the electromagnetic coil 19 and then concentrated in the outer core 24, when applying an alternating current to the corresponding electromagnetic coil 19, the alternating magnetic field producing a force for reciprocating the permanent magnet 18 in the direction of the axis Z. This force causes the piston 15 to be reciprocated in the direction of the axis Z inside the cylinder 7, the piston 15 being connected to the supporting member 17 to which the permanent magnet 18 is fixed. Here, a gas in the compression chamber C formed between the piston 15 and the displacer 8 is compressed as the piston 15 moves close to the displacer 8. The gas thus compressed then successively travels through the second communication hole 12, the heat dissipating fin 13, the first communication hole 11, the vent holes 8B, the regenerator 10 and the vent holes 8A before arriving at the expansion chamber E inside the heat absorbing block 5, thereby causing the displacer 8 to be pushed down toward the piston 15 by a given phase difference. Meanwhile, a negative pressure is resulted in the compression chamber C as the piston 15 moves away from the displacer 8, thereby causing the gas in the expansion chamber E to successively travel through the vent holes 8A, the regenerator 10, the vent holes 8B, the first communication hole 11, the heat dissipating fin 13 and the second communication hole 12 before returning to the compression chamber C, thus causing the displacer 8 to be pushed up and away from the piston 15 by a given phase difference. During such process, a reversible cycle effected by an isothermal change and an isovolumetric change is established, thus resulting in a low temperature in the vicinity of the expansion chamber E and a high temperature in the vicinity of the compression chamber C. Here, although the aforementioned vibration absorbing unit 33 serves to absorb a vibration resulting from the reciprocating movements of the piston 15 and the displacer 8, there may still be a slight amount of vibration that cannot be absorbed. However, since the cylinder 7, the mount 25 and the connecting arms 30 are integrally formed together, it is impossible that the coupling of the cylinder 7, the mount 25 and the connecting arms 30 will loosen due to vibration, thereby maintaining strengths and precisions for a long period of time.

As mentioned above, the thickness L1 of the flange section 20B in the direction of the axis Z is formed slightly larger than the depth L2 of the concave groove 25C in the direction of the axis Z (L1>L2). For this reason, the flange section 20B, when inserted into the concave groove 25C, slightly protrudes from the second side surface 25B of the mount 25. Further, the retainer plate 26 is screwed to the second side surface 25B of the mount 25 through the screws 27. At that time, the retainer plate 26 undergoes an elastic deformation in which an inner circumference thereof moves away from the second side surface 25B when pushed by the flange section 20B. Accordingly, the flange section 20B receives from the retainer plate 26 an elastic restoring force F for pushing the corresponding flange section 20B toward the concave groove 25C, in the direction of the axis Z.

Since the inner core 20 is held at a proximal end of the mount 25 due to the elastic force applied by the retainer plate 26, the retainer plate 26 can keep holding the flange section 20B even when the cylinder 7 and the mount 25 expand more largely than the inner core 20, thereby avoiding, for example: deformations of the cylinder 7 and the inner core 20; and a tremble of the inner core 20. Further, since the inner core 20 is held at the proximal end of the mount 25 due to the elastic force applied by the retainer plate 26, no impurity gas will be generated due to changes over time. Furthermore, since there is employed a structure in which the inner core 20 and the piston 15 are adjacent to each other with no cylinder 7 disposed therebetween, an increase in an outer diameter of the driving mechanism 16, eventually, an outer diameter of the casing 1 can be restricted. Here, since a depth of the concave section 20A is formed slightly smaller than a thickness of the extended section 7A, an inner diameter of the inner core 20 can be formed slightly larger than that of the cylinder 7, thereby reducing: an outer diameter of the inner core 20; and the outer diameter of the driving mechanism 16, eventually, the outer diameter of the casing 1.

As mentioned above, the Stirling cycle engine of the present embodiment includes: the piston 15 capable of being reciprocated inside the cylinder 7; and the driving mechanism 16 composed of the stator unit 16A and the movable unit 16B. The movable unit 16B includes the permanent magnet 18. Further, the movable unit 16B is fixed to the piston 15 and is actually disposed outside the corresponding piston 15. The stator unit 16A includes the cylindrical inner core 20, the outer core 24 and the electromagnetic coil 19. The inner core 20 is disposed inside the movable unit 16B, and the outer core 24 and the electromagnetic coil 19 are disposed outside the permanent magnet 18. Here, the flange section 20B serving as a fitting section is formed on one end of the inner core 20. Further, there is provided the retainer plate 26 serving as a retaining member corresponding to the flange section 20B. The retainer plate 26 is disposed to hold and fix the flange section 20B of the inner core 20 with the aid of the second side surface 25B of the mount 25 serving as an end section of the cylinder 7, thus allowing the cylinder 7 and the inner core 20 to be substantially coaxially arranged.

Here, even when there exists a thermal expansion difference between the cylinder 7 and the inner core 20 due to a difference in materials thereof, the generation of impurity gas can be prevented; the cylinder 7 and the inner core 20 are less likely to deform; the inner core 20 is less likely to tremble. In addition, it is no longer required that the cylinder 7 have a conventional proximal end portion needed to fix the inner core 20, thus reducing the outer diameter of the driving mechanism 16, eventually, the outer diameter of the casing 1.

Further, the Stirling cycle engine of the present embodiment employs the retainer plate 26 as an elastic member. The retainer plate 26 abuts against the flange section 20B of the inner core 20 while being elastically deformed, and serves to hold and fix the corresponding flange section 20B with the aid of the second side surface 25B of the mount 25 integrally formed on the cylinder 7. Accordingly, even when the cylinder 7 and the mount 25 expand more largely than the inner core 20, the retainer plate 26 can keep holding the flange section 20B so as to prevent the inner core 20 from trembling.

### Second Embodiment

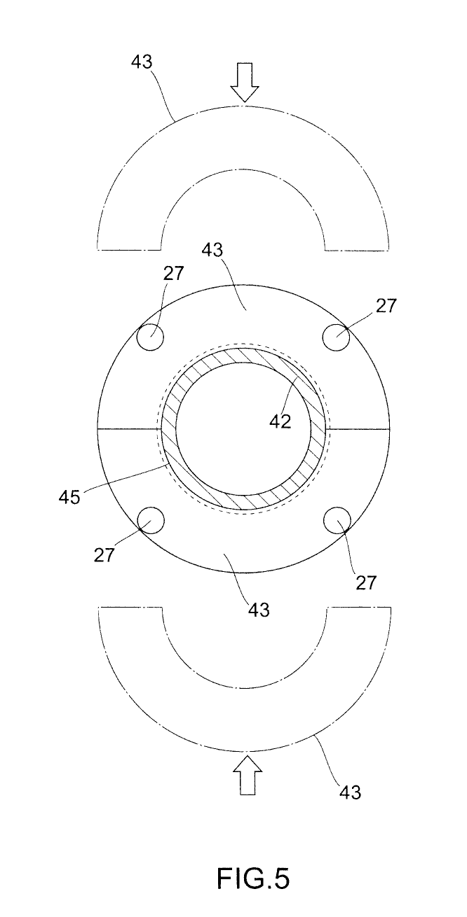

A second embodiment of the present invention is described hereunder with reference to FIG. 4 and FIG. 5. As is the case in the first embodiment, an upper side and a lower side in FIG. 4 are defined as a distal end side and a proximal end side, respectively. The second embodiment is identical to the first embodiment except for a cylinder 41, an inner core 42 and a retainer plate 43 serving as a retaining member. An extended section 41A extends from a proximal end side section of the cylinder 41 in the direction of the axis Z. Further, a concave section 42A corresponding to the extended section 41A is formed on an inner side of a distal end section of the inner core 42. The extended section 41A and the concave section 42A allow the inner core 42 to be positioned to the cylinder 41. Further, a flange-shaped mount 44 is integrally formed on a proximal end section of the cylinder 41 in a manner such that the mount 44 coaxially protrudes therefrom. The mount 44 is so configured that a first side surface 44A formed on a distal end side thereof abuts against and is screwed to the mounting section 4A of the coupling member 4 partially composing the casing 1. Meanwhile, on a second side surface 44B located on a proximal end side of the mount 44, there is formed an annular concave groove 44C surrounding the extended section 41A. Here, a distal end section 42B of the inner core 42 can be inserted into the concave groove 44C in the direction of the axis Z. Further, a concave groove 45 serving as a fitting section is formed on an outer circumference of a distal-end side section of the inner core 42. A distance M1 between a distal end of the inner core 42 and a distal-end side wall 45A of the concave groove 45 in the direction of the axis Z, is formed slightly larger than a depth M2 of the concave groove 44C in the direction of the axis Z (M1>M2). For this reason, with the distal end section 42B of the inner core 42 being inserted into the concave groove 44C, the distal-end side wall 45A of the concave groove 45 of the inner core 42 slightly protrudes from the second side surface 44B toward the proximal end side of the axis Z. Further, screwed to a proximal end side of the concave groove 44C of the second side surface 44B through the screws 27, is the aforementioned ring-shaped retainer plate 43 coaxially disposed with respect to the cylinder 41 and the inner core 42. An inner diameter N1 of the retainer plate 43 is formed smaller than an outer diameter N2 of the concave groove 44C and an outer diameter N3 of the distal end section 42B of the inner core 42 (N1<N2, N1<N3). However, the inner diameter N1 of the retainer plate 43 is substantially identical to an inner diameter N4 of the concave groove 45 (N1=N4). Here, the retainer plate 43 is made of an elastic material such as spring steel, stainless steel or the like, and can be divided into multiple pieces.

With the inner core 42 being positioned to the cylinder 41 through the extended section 41A and the concave section 42A, the distal end section 42B is to be inserted into the concave groove 44C. Next, with inner circumferential sections of the divided retainer plate 43 being inserted into the concave groove 45, the screws 27 are used to screw the corresponding retainer plate 43, thereby allowing the retainer plate 43 and the concave groove 44C to hold and fix, in the direction of the axis Z, the portion of the inner core 42 ranging from the distal end thereof to the distal-end side wall 45A of the concave groove 45.

As mentioned above, the distance M1 between the distal end of the inner core 42 and the distal-end side wall 45A of the concave groove 45 in the direction of the axis Z, is formed slightly larger than the depth M2 of the concave groove 44C in the direction of the axis Z (M1>M2). Therefore, with the distal end section 42B of the inner core 42 being inserted into the concave groove 44C, the distal-end side wall 45A of the concave groove 45 of the inner core 42 slightly protrudes from the second side surface 44B. Thus, when screwing to the second side surface 44B of the mount 44 the multiple retainer plates 43 through the screws 27, the inner circumferential sections of the multiple retainer plates 43 undergo elastic deformation in a direction away from the second side surface 44B as a result of being pushed by the distal-end side wall 45A of the concave groove 45. Accordingly, the distal-end side wall 45A of the concave groove 45 receives from the multiple retainer plates 43 an elastic restoring force F for pushing the corresponding distal-end side wall 45A toward the concave groove 44C, in the direction of the axis Z.

Since the inner core 42 is held at a proximal end of the mount 44 due to the elastic force applied by the multiple retainer plates 43, the multiple retainer plates 43 can keep holding the distal-end side wall 45A of the concave groove 45 even when the cylinder 41 and the mount 44 expand more largely than the inner core 42, thereby avoiding, for example: deforming the cylinder 41 and the inner core 42; and trembling the inner core 42. Further, since the inner core 42 is held at the proximal end of the mount 44 due to the elastic force applied by the multiple retainer plates 43, no impurity gas will be generated due to changes over time. Furthermore, since there is employed a structure in which the inner core 42 and the piston 15 are adjacent to each other with no cylinder 41 disposed therebetween, the increase in the outer diameter of the driving mechanism 16, eventually, the outer diameter of the casing 1 can be restricted. Here, since a depth of the concave section 42A is formed slightly smaller than a thickness of the extended section 41A, an inner diameter of the inner core 42 can be formed slightly larger than that of the cylinder 41, thereby reducing: an outer diameter of the inner core 42; and the outer diameter of the driving mechanism 16, eventually, the outer diameter of the casing 1.

As mentioned above, the Stirling cycle engine of the present embodiment includes: the piston 15 capable of being reciprocated inside the cylinder 41; and the driving mechanism 16 composed of the stator unit 16A and the movable unit 16B. The movable unit 16B includes the permanent magnet 18. Further, the movable unit 16B is fixed to the piston 15 and is actually disposed outside the corresponding piston 15. The stator unit 16A includes the cylindrical inner core 42, the outer core 24 and the electromagnetic coil 19. The inner core 42 is disposed inside the movable unit 16B, and the outer core 24 and the electromagnetic coil 19 are disposed outside the permanent magnet 18. Here, the concave groove 45 serving as a fitting section is formed on one end of the inner core 42. Further, there are provided the multiple retainer plates 43 serving as retaining members corresponding to the concave groove 45. The multiple retainer plates 43 are disposed to hold and fix, with the aid of the second side surface 44B of the mount 44 serving as an end section the cylinder 41, the portion of the inner core 42 ranging from the distal end thereof to the distal-end side wall 45A of the concave groove 45. In this way, the cylinder 41 and the inner core 42 can be substantially coaxially arranged.

Here, even when there exists a thermal expansion difference between the cylinder 41 and the inner core 42 due to a difference in materials thereof, the generation of impurity gas can be prevented; the cylinder 41 and the inner core 42 are less likely to deform; the inner core 42 is less likely to tremble. In addition, it is no longer required that the cylinder 41 have a conventional proximal end portion needed to fix the inner core 42, thus reducing the outer diameter of the driving mechanism 16, eventually, the outer diameter of the casing 1.

Further, the Stirling cycle engine of the present embodiment employs the multiple retainer plates 43 as elastic members. The multiple retainer plates 43 abut against the distal-end side wall 45A of the concave groove 45 while being elastically deformed, and serve to hold and fix, with the aid of the second side surface 44B of the mount 44 integrally formed on the cylinder 41, the portion of the inner core 42 ranging from the distal end thereof to the distal-end side wall 45A of the concave groove 45. Accordingly, even when the cylinder 41 and the mount 44 expand more largely than the inner core 42, the multiple retainer plates 43 can keep holding the distal-end side wall 45A of the concave groove 45 so as to prevent the inner core 42 from trembling.

However, the present invention is not limited to the aforementioned embodiments. In fact, various modified embodiments are possible within the scope of the gist of the present invention. For example, although the aforementioned embodiments employ a fitting section and a retaining member that are both formed into the shapes of rings, the fitting section and the retaining member actually do not have to be formed into the shapes of rings as long as the fitting section can be held by the retaining member and the proximal end side section of the cylinder.

What is claimed:

1. A Stirling cycle engine comprising:
a cylinder;
a piston capable of being reciprocated inside said cylinder;
a driving mechanism comprising:
a movable unit including a permanent magnet and being fixed to and disposed outside said piston; and
a stator unit including a cylindrical inner core disposed inside said movable unit, and an outer core and an electromagnetic coil that are disposed outside said movable unit;
a fitting section formed on one end of said inner core; and
a retaining member, corresponding to said fitting section,
wherein said retaining member serves to hold and fix said fitting section of said inner core with an aid of an end section of said cylinder such that said cylinder and said inner core can be substantially coaxially arranged.

2. The Stirling cycle engine according to claim 1, wherein said fitting section is a flange-shaped section formed on the one end of said inner core, and said retaining member is a ring-shaped member.

3. The Stirling cycle engine according to claim 1, wherein said fitting section is a concave groove formed on an outer circumference of the one end of said inner core, and said retaining member is a ring-shaped member inserted into said fitting section.

4. The Stirling cycle engine according to claim 1, wherein said retaining member is an elastic member, and abuts against said fitting section while being elastically deformed.

5. The Stirling cycle engine according to claim 2, wherein said retaining member is an elastic member, and said fitting section is formed to a thickness larger than a depth of a concave groove formed on the end section of said cylinder, thereby allowing said fitting section to protrude from the end section of said cylinder when inserted into said concave groove, thus causing said retaining member, when fixed to the end section of said cylinder, to abut against said fitting section while being elastically deformed.

6. The Stirling cycle engine according to claim 3, wherein said retaining member is an elastic member, and a distance between the one end of said inner core and a side wall in said fitting section of said inner core is larger than a depth of a concave groove formed on the end section of said cylinder, thereby allowing said side wall in said fitting section of said inner core to protrude from the end section of said cylinder with the one end of said inner core being inserted into said concave groove, thus causing said retaining member, when fixed to the end section of said cylinder, to abut against said fitting section while being elastically deformed.
